(19) United States
(12) Patent Application Publication
(10) Pub. No.: US 2013/0265893 A1
(43) Pub. Date: Oct. 10, 2013

(54) APPARATUS FOR ANALYZING INTERFERENCE OF WIRELESS COMMUNICATION DEVICE, AND SYSTEM AND METHOD FOR ANALYZING INTERFERENCE USING THE SAME

(71) Applicant: Electronics and Telecommunications Research Institute, (US)

(72) Inventors: Su Na CHOI, Daejeon (KR); Sung Woong CHOI, Daejeon (KR); Sang Bong JEON, Daejeon (KR); Seung Keun PARK, Daejeon (KR)

(73) Assignee: Electronics and Telecommunications Research Institute, Daejeon (KR)

(21) Appl. No.: 13/738,379

(22) Filed: Jan. 10, 2013

(30) Foreign Application Priority Data
Apr. 4, 2012 (KR) 10-2012-0035011

(51) Int. Cl. H04B 17/00

(52) U.S. Cl. CPC H04B 17/00
USPC 370/252

(57) ABSTRACT

An apparatus for analyzing interference of a wireless communication device includes a frequency detector configured to detect a frequency signal in a low frequency band that is generated in a wireless communication device; and a band-pass filter configured to extract an interference signal reflecting auditory sensitivity at each frequency, in an audible frequency band of the detected frequency signal. Further, the apparatus includes a voltmeter configured to measure a magnitude of the extracted interference signal at each frequency; and an interference determination block configured to determine whether there is an influence of interference of the wireless communication device on an audio device by comparing an interference level of the measured interference signal with a preset interference reference value.

### CROSS-REFERENCE TO RELATED APPLICATION(S)

The present invention claims priority of Korean Patent Application No. 10-2012-0035011, filed on Apr. 4, 2012, which is incorporated herein by reference.

### FIELD OF THE INVENTION

The present invention relates to a technique for analyzing the interference of a wireless communication device; and more particularly, to an apparatus for analyzing the interference of a wireless communication device, which is suitable for analyzing the frequency interference of a wireless communication device with an audio device using signals in the audible frequency band, and a system and method for analyzing interference using the apparatus.

### BACKGROUND OF THE INVENTION

As is well known, wireless communication devices are being widely used to send sound signals and data. Recently, the population that is using wireless communication devices has explosively increased. In general, wireless communication devices use radio frequency (RF) carrier frequencies to perform wireless communication and perform communication at high frequencies above the audible frequency band.

Accordingly, the interest in the influence of wireless communication devices on audio devices has been focused on frequency signals that are sent via the carrier frequency band, and thus research into and the study of the interference of wireless communication devices with audio devices in the audible frequency band and its influence have not attracted attention.

In the meantime, wireless communication technology utilizes a technique for appropriately distributing resources, such as time and frequencies, and providing the resources to users in order to accommodate an increasing number of users. For example, wireless communication devices to which Time Division Multiple Access (TDMA) or Orthogonal Frequency Division Multiple Access (OFDMA), which are techniques that divide the time per frame and thus accommodate a large number of users, has been applied repeatedly perform the operation of alternately sending and non-sending signals at regular intervals, with the result that the problem of incurring undesired frequency components in a low frequency band corresponding to the audible frequency band arises.

As is well known, the human audible frequency band ranges from 20 Hz to 20 kHz. A wireless communication device having a frequency component in the above frequency band may incur interference with an audio device using signals in the audible frequency band, such as a speaker, and thus may generate undesired sound noise.

Accordingly, there is an urgent need for a new analysis technique that can be used to overcome the problem of the interference of a wireless communication device with an audio device. However, currently, there are not any proposals for such a new analysis technique.

### SUMMARY OF THE INVENTION

In view of the above, the present invention provides an apparatus for analyzing the interference of a wireless communication device, which is suitable for analyzing the frequency interference of a wireless communication device with an audio device using signals in the audible frequency band, and a system and method for analyzing interference using the apparatus.

In accordance with a first aspect of the present invention, there is provided an apparatus for analyzing interference of a wireless communication device, including: a frequency detector configured to detect a frequency signal in a low frequency band that is generated in a wireless communication device; a band-pass filter configured to extract an interference signal reflecting auditory sensitivity at each frequency, in an audible frequency band of the detected frequency signal; a voltmeter configured to measure a magnitude of the extracted interference signal at each frequency; and an interference determination block configured to determine whether there is an influence of interference of the wireless communication device on an audio device by comparing an interference level of the measured interference signal with a preset interference reference value.

In accordance with a second aspect of the present invention, there is provided a system for analyzing interference of a wireless communication device, including: a wireless communication device configured to wirelessly communicate with a wireless transmission and reception device; an apparatus for analyzing interference configured to detect a frequency signal in a low frequency band that is generated in the wireless communication device, to extract an interference signal reflecting auditory sensitivity at each frequency in an audible frequency band, to measure a magnitude of the extracted interference signal at each frequency, and to determine whether there is an influence of interference of the wireless communication device on an audio device by comparing an interference level of the measured interference signal with a preset interference reference value; and a location adjustment device configured to adjust an interval between or locations of the wireless communication device and the apparatus for analyzing interference.

In accordance with a third aspect of the present invention, there is provided a method of analyzing interference of a wireless communication device, including: setting a test environment for analysis of the interference of the wireless communication device; measuring an interference signal of the wireless communication device using an apparatus for analyzing interference; comparing an interference level of the measured interference signal with a preset interference reference value; determining whether there is influence of the interference of the wireless communication device on an audio device by the comparison to store resulting values of the determination in a database (DB); repeating said measuring an interference signal to said determining whether there is influence of the interference to store resulting values after varying an interval between or locations of the wireless communication device and the apparatus for analyzing interference; and repeating said measuring an interference signal to said determining whether there is influence of the interference to store resulting values a specific number of times that correspond to a predefined number of tests.

The present invention is configured to detect a frequency signal in a low frequency band that is generated in a wireless communication device, extracts an interference signal reflecting auditory sensitivity at each frequency in an audible frequency band, and measure the magnitude of the extracted interference signal at each frequency, so that the resulting values can be used to determine the level of interference of the wireless communication device with the audio device and the level of resistance of the audio device, thereby being able to provide high-query wireless communication device and audio device services.

### BRIEF DESCRIPTION OF THE DRAWINGS

The above and other objects and features of the present invention will become apparent from the following description of embodiments given in conjunction with the accompanying drawings, in which:

FIG. 1A shows the signal format of Global System for Mobile Communications (GSM) mobile phones that perform communication using TDMA, FIG. 1B shows the form of signals in the time domain, and FIG. 1C shows a frequency spectrum in the audible frequency band when communication is performed for a minimum unit time;

FIG. 2A shows the signal format of Long Term Evolution (LTE) mobile phones that perform communication using OFDMA, FIG. 2B shows the form of signals in the time domain, and

FIG. 2C shows a frequency spectrum in the audible frequency band when communication is performed for a minimum unit time;

FIG. 3 is a graph showing auditory sensitivity at each frequency in the human audible frequency band;

FIG. 4 is a block diagram showing the configuration of an apparatus for analyzing the interference of a wireless communication device according to the present invention;

FIG. 5 is a graph showing sensitivity weighting values for the frequencies of a band-pass filter that is included in the apparatus for analyzing interference according to the present invention;

FIG. 6 is a block diagram showing the configuration of a system for analyzing the interference of a wireless communication device that is constructed using the apparatus for analyzing interference shown in FIG. 4 according to the present invention; and

FIG. 7 is a flowchart showing the process of analyzing the interference of a wireless communication device using the apparatus for analyzing interference according to the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings so that they can be readily implemented by those skilled in the art.

As is well known, wireless communication devices for performing wireless communication perform communication using RF carrier frequencies at frequencies higher than the audible frequency band. For example, wireless communication devices using a technique for dividing time according to a specific frame cycle and then performing communication may incur undesired frequency spectra, reflecting the characteristic, in a low frequency band.

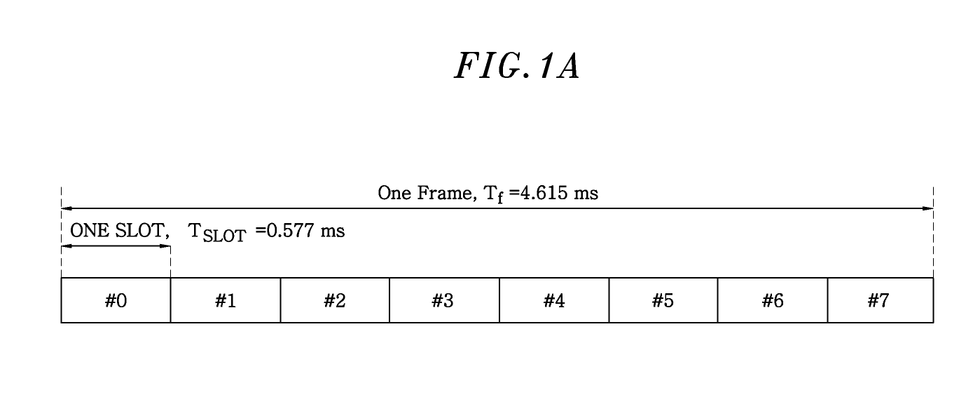

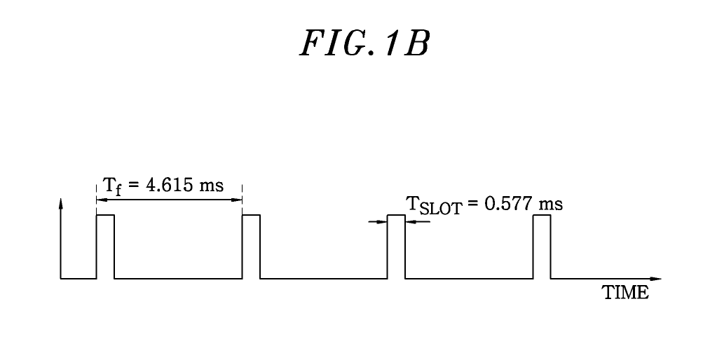

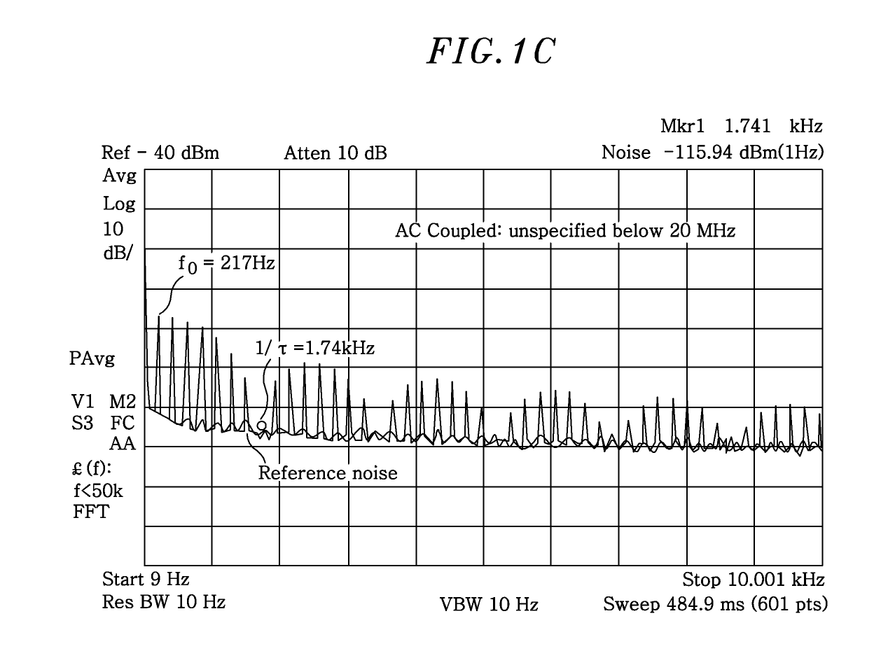

FIG. 1A shows the signal format of Global System for Mobile Communications (GSM) mobile phones that perform communication using TDMA, FIG. 1B shows the form of signals in the time domain, and FIG. 1C shows a frequency spectrum in the audible frequency band when communication is performed for a minimum unit time. It can be seen that each frame of GSM mobile phones has a period of 4.615 ms and is composed of eight slots, that is, a minimum transmission unit.

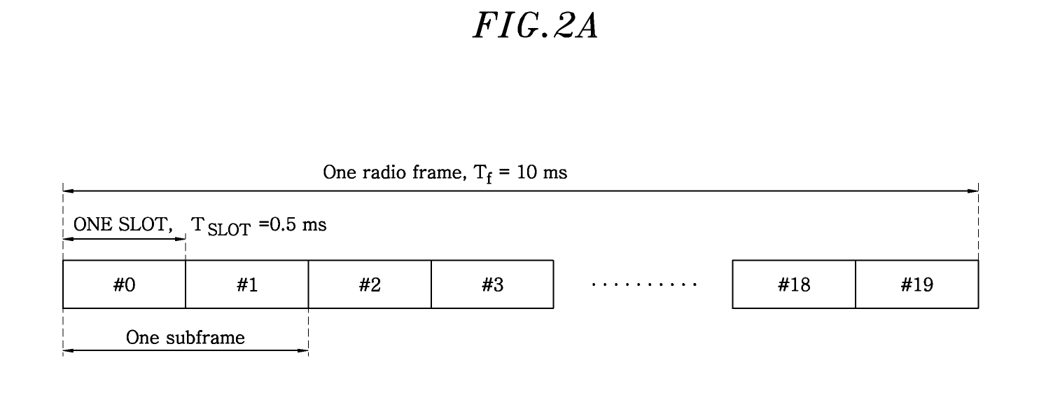

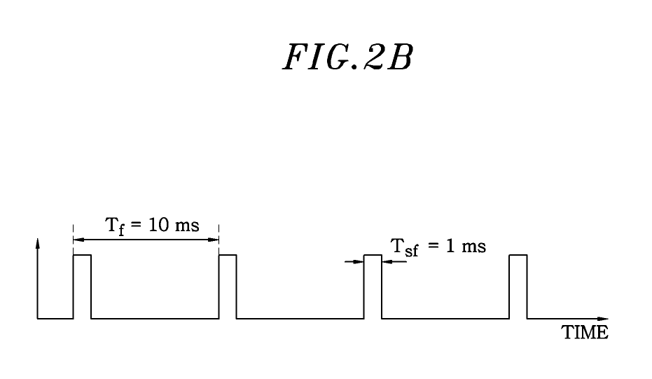

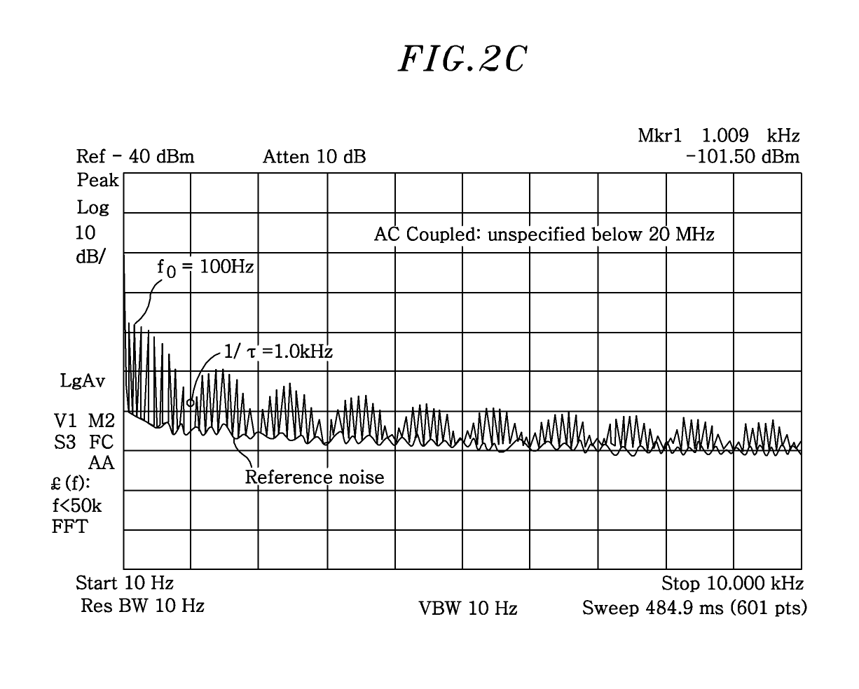

FIG. 2A shows the signal format of Long Term Evolution (LTE) mobile phones that perform communication using OFDMA, FIG. 2B shows the form of signals in the time domain, and FIG. 2C shows a frequency spectrum in the audible frequency band when communication is performed for a minimum unit time. It can be seen that each frame of LTE mobile phones has a period of 10 ms and is composed of 10 sub-frames, that is, a minimum transmission unit.

As can be seen from FIGS. 1A to 2C, such wireless communication devices have undesired frequency spectra in the human audible frequency band. Such spectra may incur interference with audio devices using the audible frequency band, and thus may generate undesired noise.

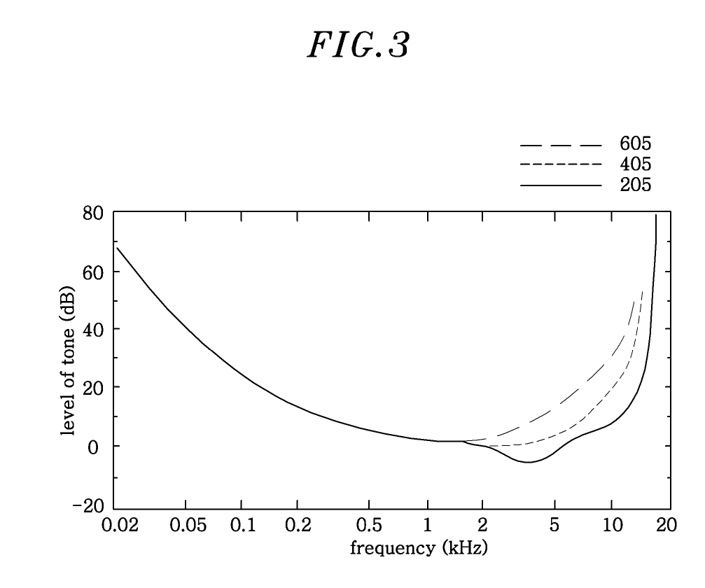

FIG. 3 is a graph showing auditory sensitivity at each frequency in the human audible frequency band. The human audible frequency band ranges from 20 Hz to 20 kHz. The auditory sensitivity varies depending on the frequency.

Accordingly, the magnitude of a sound that a human senses from even a signal having the same magnitude may vary depending on the frequency value that the signal has in the audible frequency range. In general, it is known that a human is most sensitive to frequencies in the frequency band of 3 kHz to 4 kHz. Furthermore, such auditory sensitivity may vary depending on the age or other various factors of each person. From FIG. 3, it can be seen that as the age increases from 20 s to 40 s and then to 60, the auditory sensitivity to high frequencies gradually decreases.

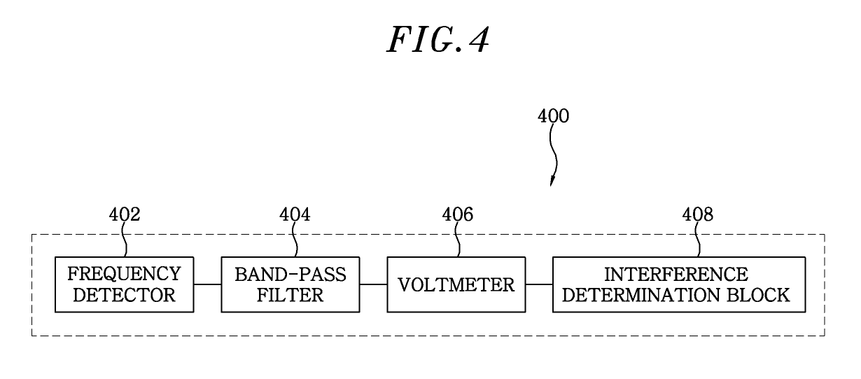

FIG. 4 is a block diagram showing the configuration of an apparatus 400 for analyzing the interference of a wireless communication device according to the present invention. The apparatus 400 for analyzing interference according to the present invention may include a frequency detector 402, a band-pass filter 404, a voltmeter 406, and an interference determination block 408.

Referring to FIG. 4, the frequency detector 402 may provide the function of detecting (recognizing) a frequency signal in a low frequency band that is generated in a wireless communication device that wirelessly communicates with a wireless transmission and reception device (not shown). Here, the detected frequency signal in a low frequency band is transferred to a band-pass filter 404 next to the frequency detector 402.

The band-pass filter 404 refers to, for example, a sensitivity weighting band-pass filter. The band-pass filter 404 may provide the function of extracting an interference signal, reflecting auditory sensitivity, at each frequency in the audible frequency band of the frequency signal detected by the frequency detector 402 and transferring the extracted interference signal to the voltmeter 406 next to the band-pass filter 404. Here, the band-pass filter 404 may use an auditory sensitivity weighting value that varies depending on the application environment (or application service) of a wireless communication device.

As an example, if it is assumed that the band-pass filter 404 is applied to a senior citizen-dedicated silver town or a children-dedicated environment, it can be seen that the auditory sensitivity of an actual user is different from an average value at each frequency, and thus it may be necessary to adjust the sensitivity weighting value depending on the application environment and apply the adjusted weighting value.

Furthermore, the voltmeter 406 may provide the function of measuring the magnitude of the extracted interference signal for each frequency and then transferring the measured magnitude to the interference determination block 408 next to the voltmeter 406.

Furthermore, the interference determination block 408 may provide the function of determining whether there is an influence of the interference of a wireless communication device on an audio device (for example, a speaker for an electronic device such as a mobile phone, a smart phone or a smart pad) by comparing the measured interference level of the interference signal with a preset interference reference value, that is, the function of determining that there is an influence of the interference of the wireless communication device on the audio device if the measured interference level of the interference signal is equal to or higher than the preset interference reference value and determining that there is no influence of the interference of the wireless communication device on the audio device if the measured interference level of the interference signal is lower than the preset interference reference value. Here, the preset interference reference value may be set within, for example, a range in which the interference with an audio device does not occur.

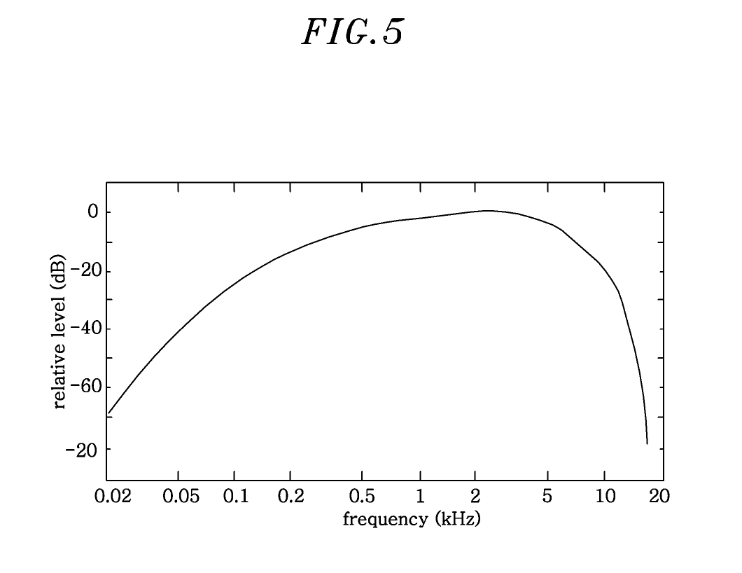

FIG. 5 is a graph showing sensitivity weighting values for the frequencies of the band-pass filter 404 that is included in the apparatus for analyzing interference according to the present invention. The sensitivity weighting value is determined by taking into consideration human auditory sensitivity for each frequency shown in FIG. 3, and enables the actually generated and felt influence of an interference signal for each frequency to be taken into consideration. However, it is preferable to vary the sensitivity weighting value depending on the application environment of a wireless communication device because auditory sensitivity may vary depending on age and other various factors.

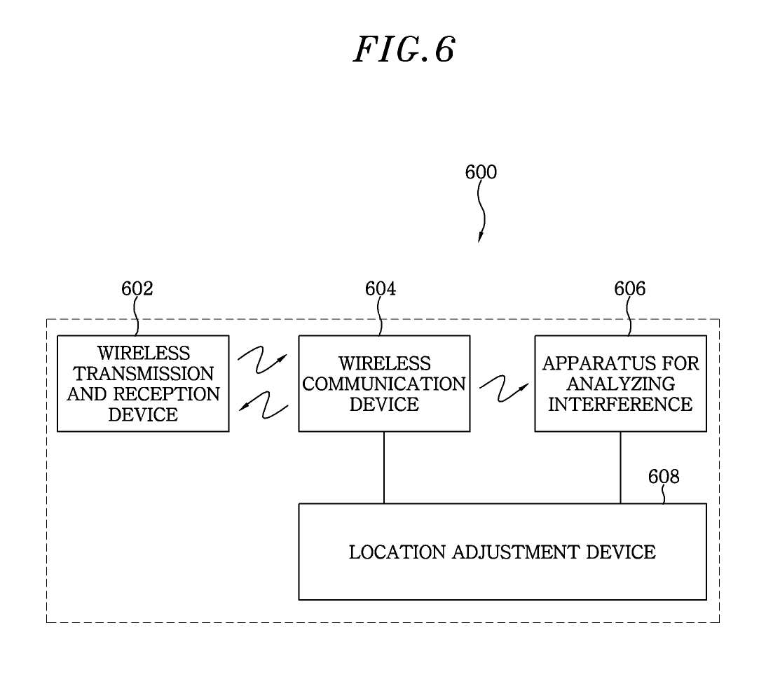

FIG. 6 is a block diagram showing the configuration of a system for analyzing the interference of a wireless communication device that is constructed using the apparatus for analyzing interference shown in FIG. 4 according to the present invention. The system 600 for analyzing interference according to the present invention may include a wireless transmission and reception device 602, a wireless communication device 604, an apparatus 606 for analyzing interference, and a location adjustment device 608.

Referring to FIG. 6, the wireless transmission and reception device 602 may perform control or adjustment so that the wireless communication device 604 generates a communication signal, and may perform the function of a separate system for communication (for example, a base station for a mobile phone) if it is necessary.

Furthermore, the wireless communication device 604 may refer to a portable terminal (or a wireless terminal or a mobile terminal), such as a mobile phone, a smart phone or a smart pad, that provides the function of generating a communication signal for wireless communication, that is, a frequency signal, under the control of the wireless transmission and reception device 602.

Although the apparatus 606 for analyzing interference is assigned a different reference numeral, it refers to a device that is the same as the apparatus 400 for analyzing interference shown in FIG. 4. The apparatus 606 for analyzing interference may provide the function of detecting a frequency signal in a low frequency band that is generated in the wireless communication device 604, extracting an interference signal reflecting auditory sensitivity at each frequency in the audible frequency band, measuring the magnitude of the extracted interference signal for each frequency, and determining that there is an influence of the interference of the wireless communication device 604 on an audio device by comparing the measured interference level of the interference signal with the preset interference reference value.

Meanwhile, the apparatus 606 for analyzing interference may store, in an external or internal database (DB; not shown), the resulting value of the termination that is obtained by comparing the measure interference level of the interference signal with the preset interference reference value. Such the resulting values of determination stored in the DB may be retrieved from the DB in response to a request from a user when necessary, and be then output (for example, via a monitor, a printer, or copying to external memory).

Furthermore, the location adjustment device 608 may provide the function of adjusting the interval (distance) between the wireless communication device 604 and the apparatus 606 for analyzing interference or the locations thereof (the relative locations over the same distance) in response to a request from a user (or the selection of a user). This function helps to determine (assess) the influence of the interference of a frequency signal in the audible frequency band that is generated in the wireless communication device 604 on an audio device over a variety of intervals between the wireless communication device 604 and the apparatus 606 for analyzing interference and at the various locations thereof. The results of the determination are applied to the assessment of the interference of the wireless communication device with the audio device and the resistance of the audio device to the interference, which is intended to provide high-quality wireless communication device and audio device-related services.

Here, the interval between the wireless communication device 604 and the apparatus 606 for analyzing interference may be varied to, for example, 1 cm, 10 cm, 20 cm and 30 cm, and the influence of interference may be measured at each of the intervals. By doing so, the distance over which there is an influence of the interference of the specific wireless communication device may be determined, and the level of the actual interference may be assessed in steps. As a result, the level at which there is no problem with actual use even when interference occurs, or the level at which application is impossible, may be determined based on the application environment.

Next, the process of assessing the influence of the interference of a wireless communication device on an audio device using the system for analyzing interference according to the present invention will be described in detail below.

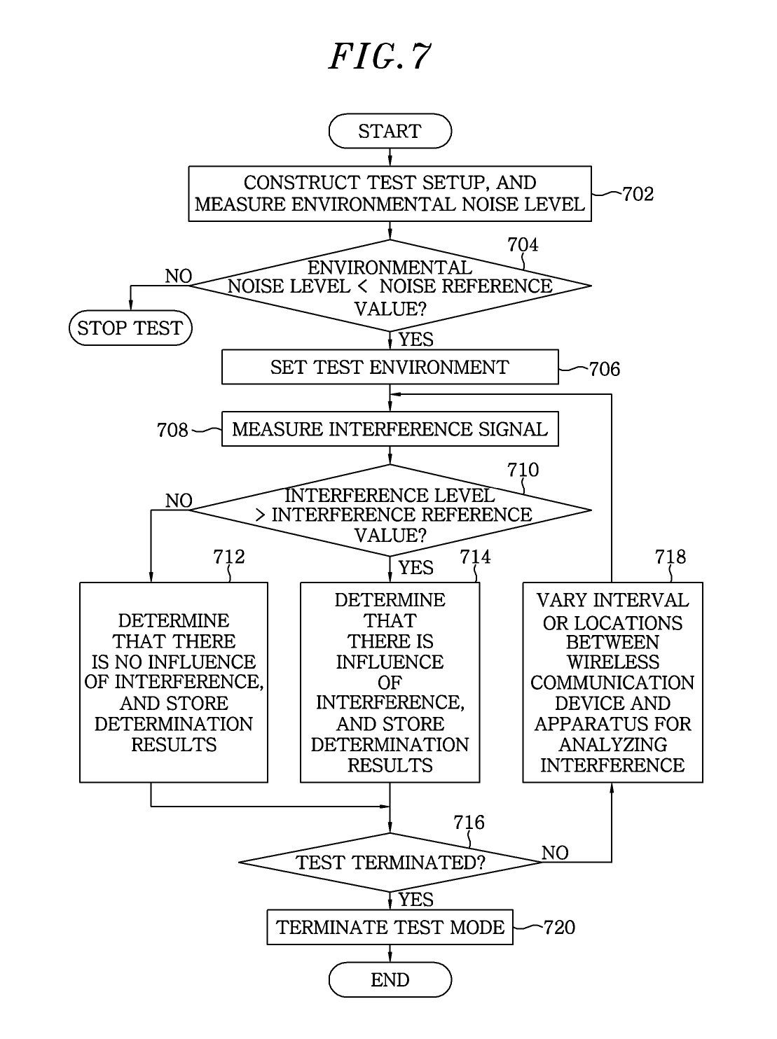

FIG. 7 is a flowchart showing the process of analyzing the interference of a wireless communication device using the apparatus for analyzing interference according to the present invention.

Referring to FIG. 7, the apparatus 606 for analyzing interference measures an environmental noise level while the wireless communication device 604 is not operating in order to determine the suitability of a test environment in a condition in which an interference test setup for the wireless communication device 604 has been constructed in operation 702.

Thereafter, in operation 704, the measured environmental noise level is compared with a preset noise reference value. If, as a result of the comparison, it is determined that the measured environmental noise level is equal to or higher than the preset noise reference value, the apparatus 606 for analyzing interference stops the test, with the result that an operator may adjust (or control) the environment of the configuration of the test setup in order to set up a normal test environment. Here, the preset noise reference value may be set within a range in which the reliability of test results is not influenced.

If, as a result of the comparison in operation 704, it is determined that the measured environmental noise level is lower than the preset noise reference value, a test environment is set, that is, the wireless communication device 604 and the wireless transmission and reception device 602 communicating the wireless communication device 604 are made to operate in operation mode in operation 706. This operation in operation mode may be performed under the control of the apparatus 606 for analyzing interference or may be controlled in response to a request from an operator (the manipulation of the operator).

In response to this, the apparatus 606 for analyzing interference measures an interference signal by the execution of the test mode, that is, a frequency signal in a low frequency band that is generated in the wireless communication device 604, extracts an interference signal reflecting auditory sensitivity at each frequency in the audible frequency band, and the magnitude of the extracted interference signal for each frequency in operation 708. Here, the weighting value for the auditory sensitivity may vary depending on the application environment of the wireless communication device 604.

Thereafter, the interference determination block of the apparatus 606 for analyzing interference determines whether there is an influence of the interference of a wireless communication device on an audio device by comparing the interference level of the measured interference signal with the preset interference reference value, that is, checks whether the interference level of the measured interference signal is lower than the preset interference reference value in operation 710. Here, the preset interference reference value may be set within, for example, a range in which interference with the audio device does not occur.

If, as a result of the check in operation 710, it is determined that the interference level of the measured interference signal is lower than the preset interference reference value, the interference determination block determines that no interference of the wireless communication device with the audio device occurs and stores the resulting value of the determination (the absence of the influence of the interference) in a DB (not shown) in operation 712.

On the other hand, if, as a result of the check in operation 710, it is determined that the interference level of the measured interference signal is equal to or higher than the preset interference reference value, the interference determination block determines that there is interference of the wireless communication device with the audio device and stores the resulting value of the determination (the presence of the influence of the interference) in the DB (not shown) in operation 714.

Thereafter, the process proceeds to operation 716, at which it is checked whether the interference analysis test has been terminated. Here, the termination of the interference analysis test may mean that a preset number of tests have been conducted by an operator or that an operator has selected the manipulation of the termination of the test.

If, as a result of the check in operation 716, it is determined that the interference analysis test has been terminated, the location adjustment device 608 varies the interval (distance) or the locations (relative locations) between the wireless communication device 604 and the apparatus 606 for analyzing interference in operation 718. Thereafter, the process proceeds to the above-described operation 708, and sequentially and repeatedly performs the following operations 710 to 716. Here, the variation of the interval or location may mean increasing the interval between the wireless communication device 604 and the apparatus 606 for analyzing interference based on a specific reference value, or varying the relative locations.

That is, according to the present invention, operations 708 to 718 are repeatedly performed, so that an operator performs a preset (predefined) number of interference analysis tests or a desired number of interference analysis tests at different intervals or locations.

If, as a result of the check in operation 716, it is determined that the interference analysis test has been terminated, the apparatus 606 for analyzing interference terminates the test mode currently being executed in operation 720. When the test mode is terminated as described above, the operations of the wireless communication device 604 and the wireless transmission and reception device 602 may be simultaneously or sequentially stopped (terminated).

Meanwhile, although not shown in FIG. 7, the apparatus 606 for analyzing interference may retrieve the resulting values of the assessment from the DB and then output them when an operator or a user makes a request for information about the results of the assessment of the influence of interference. Here, the output may mean, for example, output to a monitor, output to a printer, and copying output to external memory.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for analyzing interference of a wireless communication device, comprising:
a frequency detector configured to detect a frequency signal in a low frequency band that is generated in a wireless communication device;
a band-pass filter configured to extract an interference signal reflecting auditory sensitivity at each frequency, in an audible frequency band of the detected frequency signal;
a voltmeter configured to measure a magnitude of the extracted interference signal at each frequency; and
an interference determination block configured to determine whether there is an influence of interference of the wireless communication device on an audio device by comparing an interference level of the measured interference signal with a preset interference reference value.

2. The apparatus of claim 1, wherein the band-pass filter is configured to apply a weighting value for the auditory sensitivity that varies depending on an application environment of the wireless communication device.

3. The apparatus of claim 1, wherein the interference determination block is configured to determine that there is an influence of the interference of the wireless communication device on the audio device if the interference level of the measured interference signal is equal to or higher than the preset interference reference value, and to determine that there is no influence of the interference of the wireless communication device on the audio device if the interference level of the measured interference signal is lower than the preset interference reference value.

4. The apparatus of claim 3, wherein the preset interference reference value is set within a range in which no interference with the audio device occurs.

5. A system for analyzing interference of a wireless communication device, comprising:
a wireless communication device configured to wirelessly communicate with a wireless transmission and reception device;
an apparatus for analyzing interference configured to detect a frequency signal in a low frequency band that is generated in the wireless communication device, to extract an interference signal reflecting auditory sensitivity at each frequency in an audible frequency band, to measure a magnitude of the extracted interference signal at each frequency, and to determine whether there is an influence of interference of the wireless communication device on an audio device by comparing an interference level of the measured interference signal with a preset interference reference value; and
a location adjustment device configured to adjust an interval between or locations of the wireless communication device and the apparatus for analyzing interference.

6. The system of claim 5, wherein the location adjustment device adjusts the interval between or locations of the wireless communication device and the apparatus for analyzing interference preset in response to a request from a user.

7. A method of analyzing interference of a wireless communication device, comprising:
setting a test environment for analysis of the interference of the wireless communication device;
measuring an interference signal of the wireless communication device using an apparatus for analyzing interference;
comparing an interference level of the measured interference signal with a preset interference reference value;
determining whether there is influence of the interference of the wireless communication device on an audio device by the comparison to store resulting values of the determination in a database (DB);
repeating said measuring an interference signal to said determining whether there is influence of the interference to store resulting values after varying an interval between or locations of the wireless communication device and the apparatus for analyzing interference; and
repeating said measuring an interference signal to said determining whether there is influence of the interference to store resulting values a specific number of times that correspond to a predefined number of tests.

8. The method of claim 7, wherein said setting a test environment comprises:
measuring an environmental noise level while the wireless communication device is not operating;
comparing the measured environmental noise level with a preset noise reference value; and
if the measured environmental noise level is lower than the preset noise reference value, setting the test environment.

9. The method of claim 8, wherein the preset noise reference value is set within a range in which reliability of test results is not influenced.

10. The method of claim 8, wherein said setting a test environment comprises operating the wireless communication device and a wireless transmission and reception device communicating with the wireless communication device in operating mode.

11. The method of claim 7, wherein the interference signal is extracted while reflecting auditory sensitivity at each frequency in an audible frequency band.

12. The method of claim 11, wherein a weighting value for the auditory sensitivity varies depending on an application environment of the wireless communication device.

13. The method of claim 11, wherein the preset interference reference value is set within a range in which no interference occurs with the audio device.

14. The method of claim 7, wherein said determining whether there is influence of the interference of the wireless communication device on an audio device comprises:
if the interference level of the measured interference signal is equal to or higher than the preset interference reference value, determining that there is an influence of the interference of the wireless communication device on an audio device; and
if the interference level of the measured interference signal is lower than the preset interference reference value, determining that there is no influence of the interference of the wireless communication device on the audio device.

15. The method of claim 7, further comprising outputting the resulting values of the determination stored in the DB in response to a request from a user.
